(19) United States
(12) Patent Application Publication
(10) Pub. No.: US 2015/0255105 A1
(43) Pub. Date: Sep. 10, 2015

(54) METHOD FOR CONTROLLING POWER OF LASER EMITTING UNIT AND ASSOCIATED APPARATUS

(71) Applicant: MEDIATEK INC., Hsin-Chu (TW)

(72) Inventors: Hsiao-Yuan Chi, New Taipei City (TW); Sheng-Chih Chang, Taoyuan County (TW)

(21) Appl. No.: 14/537,918

(22) Filed: Nov. 11, 2014

Related U.S. Application Data
(60) Provisional application No. 61/949,248, filed on Mar. 7, 2014.

(51) Int. Cl. G11B 7/1263

(52) U.S. Cl. CPC G11B 7/1263

(57) ABSTRACT

A method for controlling a power of a laser emitting unit includes: receiving a reflected light from an object, where the object reflects light emitted from the laser emitting unit; determining a power of the reflected light; and determining a control signal by referring to a level of the power of the reflected light to control the power of the laser emitting unit.

### CROSS REFERENCE TO RELATED APPLICATIONS

This application claims the priority of US Provisional Application No. 61/949,248, filed on Mar. 7, 2014, which is included herein by reference in its entirety.

### BACKGROUND

Ina conventional optical pick-up head unit (OPU) of a selective laser sintering (SLS) machine or an optical disc drive, a front monitor photodiode sensor (FMD) is used for measuring a power of a laser diode to compensate/adjust the power of the laser diode. However, the FMD increases the manufacturing cost of the OPU.

In addition, the characteristics of the power of the laser diode will be varied under an environment of varied temperatures, therefore, the conventional OPU may include a temperature sensor to obtain the current temperature, and the OPU needs to find the relationship between the laser power and laser driving current under many different temperatures to build many models, and the OPU may select one model to compensate/adjust the power of the laser diode. However, the temperature sensor also increases the manufacturing cost of the OPU, and it may be difficult to find the appropriate model due to the varied characteristics of the laser diode and/or laser diode aging issue.

### SUMMARY

It is therefore an objective of the present invention to provide a method for controlling a power of a laser emitting unit and associated apparatus, which may compensate/adjust the power of the laser diode by using a determined power of a reflected light sensed by a photo detector integrated circuit (PDIC), that is the FMD and the temperature sensor are not used to save the manufacturing cost, and the method and apparatus of the present invention does not need to build models and the power of the laser diode can be accurately compensated even under laser diode aging issue.

According to one embodiment of the present invention, a method for controlling a power of a laser emitting unit comprises: receiving a reflected light from an object, where the object reflects light emitted from the laser emitting unit; determining a power of the reflected light; and determining a control signal by referring to a level of the power of the reflected light to control the power of the laser emitting unit.

According to another embodiment of the present invention, an apparatus for controlling a power of a laser emitting unit comprises a photo detector integrated circuit and power control circuit. The photo detector integrated circuit is arranged for receiving a reflected light from an object, where the object reflects light emitted from the laser emitting unit. The power control circuit is coupled to the photo detector integrated circuit, and is arranged for determining a power of the reflected light, and determining a control signal by referring to a level of the power of the reflected light to control the power of the laser emitting unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a SLS machine according to one embodiment of the present invention.

FIG. 2 is a diagram showing a power-control signal curves generated off-line and on-line.

FIG. 3 is a diagram illustrating an optical disc drive according to one embodiment of the present invention.

FIG. 4 is a flow chart of a method for controlling a power of the LD according to a first embodiment of the present invention.

FIG. 5 is a diagram showing a power-control signal curves generated off-line and on-line.

FIG. 6 is a diagram illustrating how to obtain the power of the reflected light of the plastic layer.

FIG. 7 is a flow chart of a method for controlling a power of the LD according to a second embodiment of the present invention.

FIG. 8 shows LBAs and corresponding powers of the reflected light.

FIG. 9 is a flow chart of a method for controlling a power of the LD according to a third embodiment of the present invention.

FIG. 10 shows the current of the LD when the optical disc drive 300 writes data into the optical disc, and the sampling signals for the sample and hold circuit.

FIG. 11 is a flow chart of a method for controlling a power of the LD according to a fourth embodiment of the present invention.

FIG. 12 is a flow chart of a method for controlling a power of the LD according to a fifth embodiment of the present invention.

FIG. 13 is a flow chart of a method for controlling a power of the LD according to a sixth embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

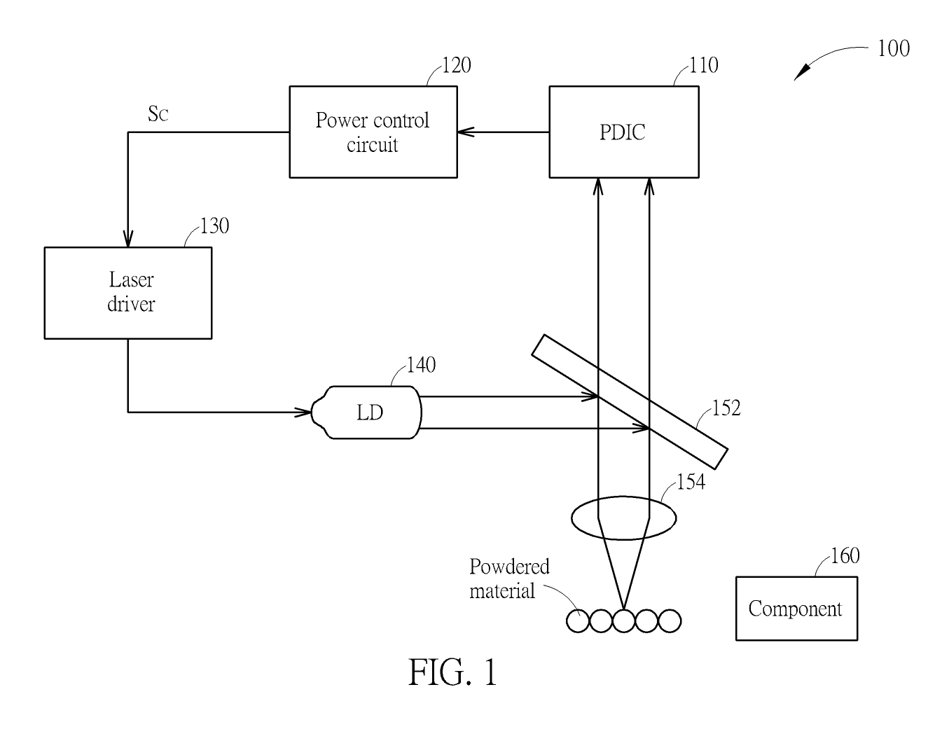

Please refer to FIG. 1, which is a diagram illustrating a SLS machine 100 according to one embodiment of the present invention, where the SLS machine uses a laser as the power source to sinter powdered material (e.g. metal powder), aiming the laser automatically at points in space defined by a 3D model, binding the powdered material together to create a solid structure. In this embodiment, the SLS machine 100 comprises a PDIC 110, a power control circuit 120, a laser driver 130, a light emitting unit (in this embodiment, a laser diode (LD) 140), two lens 152 and 154, and a component 160, where the component 160 can be any component having a suitable surface or smooth surface for reflecting light emitted from the LD 140.

In the operations of the SLS machine 100, the power control circuit 120 is arranged for generating a control signal S_{c}, and the laser driver 130 receives the control signal S_{c} to control a current of the LD 140 (i.e. control a power of the LD 140). Then, the LD 140 emits light to the powdered material via the lens 150 and 154 to sinter the powdered material. However, because the relationship between the control signal S_{c} generated by the power control circuit 120 and the power of the LD 140 may not be always the same, therefore, the PDIC 110 and the power control circuit 120 provide a mechanism to accurately compensate/adjust the power of the LD 140. It is noted that the control signal S_{c} generated by the power control circuit 120 can be implemented by many types. For example but not limited to, the control signal can be a control voltage, a control current or a DSP (digital signal processor) parameter for the laser driver 130, and the DSP parameter can be an auto power control parameter saved in a DAC (digital analog converter) register.

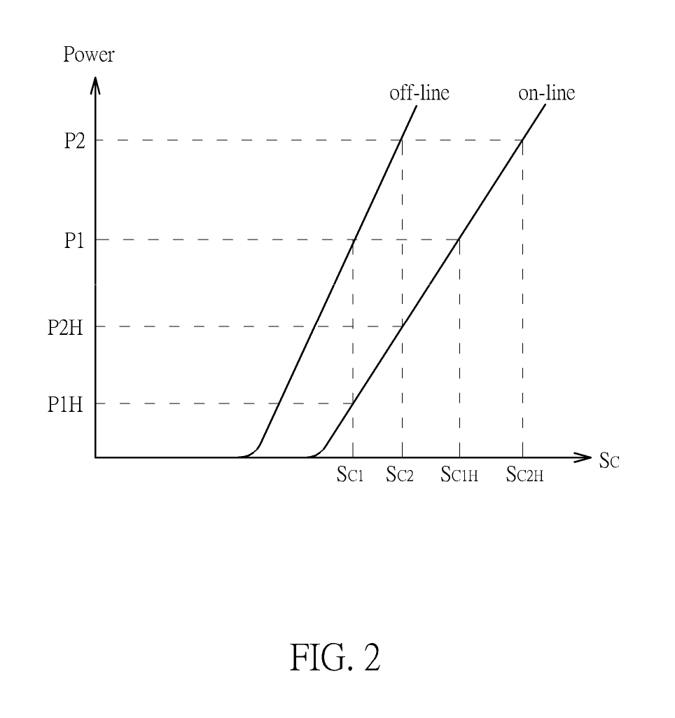

In the operations of the PDIC 110 and the power control circuit 120, the PDIC 110 receives the reflected light from the powdered material, and the power control circuit 120 determines a power of the reflected light, and determines the control signal in response to the power of the reflected light to control the power of the LD 140. In detail, referring to FIG. 2, which is a diagram showing a power-control signal curves generated off-line and on-line. When the SLS machine 100 is in the production line, the power control circuit 120 generates at least two control signals S_{c1} and S_{c2} to control the power of the LD 140, and the PDIC 110 receives the reflected light (from the powdered material) corresponding to the control signals S_{c1} and S_{c2}, respectively. Then, the power control circuit 120 can build an off-line power-control signal curve. It is noted that, in the embodiment it is assumed that the relationship (e.g. the ratio) between the power of the LD 140 and the power of the reflected light from the powdered material is determined and is always the same, therefore, the term “power” shown in FIG. 2 can refer to the power of the LD 140 or the power of the reflected light sensed by the PDIC 110. In other words, in the production line, the relationship between power of the LD 140/reflected power/control signal S_{c} are known.

When the SLS machine 100 is in use, because the off-line power-control signal curve may not be appropriate for use to compensate/adjust the power of the LD 140 due to the environment issue or laser diode aging issue, the power control circuit 120 generates at least two control signals S_{c1H} and S_{c2H} to control the power of the LD 140, and the PDIC 110 receives the reflected light (from the powdered material) corresponding to the control signals S_{c1H} and S_{c2H}, respectively. Then, the power control circuit 120 can build an on-line power-control signal curve. Therefore, when the SLS machine 100 is in use, the PDIC 110 may continuously receive the reflected light, and the power control circuit 120 may continuously determine the power of the reflected light received by the PDIC 110, or may periodically determine the power of the reflected light received by the PDIC 110, to generate the control signal S_{c} by referring to a level of the power of the reflected light to compensate/adjust the power of the LD 140.

For example, assuming that the LD 140 is required to emit light having power PW1, and because the power of the reflected light from the powdered material is determined and is always the same, the target power of the reflected light is known (hereafter PW2). Therefore, the power control circuit 120 may refer to the power of the reflected light to compensate/adjust the power of the LD 140 to make the power of the reflected light equal to or closer to PW2, and at this time the LD 140 should have the required power PW1.

In addition, in the above-mentioned embodiment, the power control circuit 120 generates the control signal S_{c} by referring to a level of the power of the reflected light from the powdered material. However, in other embodiment, the power control circuit 120 may generate the control signal S_{c} by referring to a level of the power of the reflected light from the component 160 such as an metal sheet within the SLS machine 100, that is when the power of the LD 140 is intended to be compensated/adjusted, the LD 140 will emit light to the component 160, and the PDIC 110 will receive the reflected light from the component 160. This alternative design shall fall within the scope of the present invention.

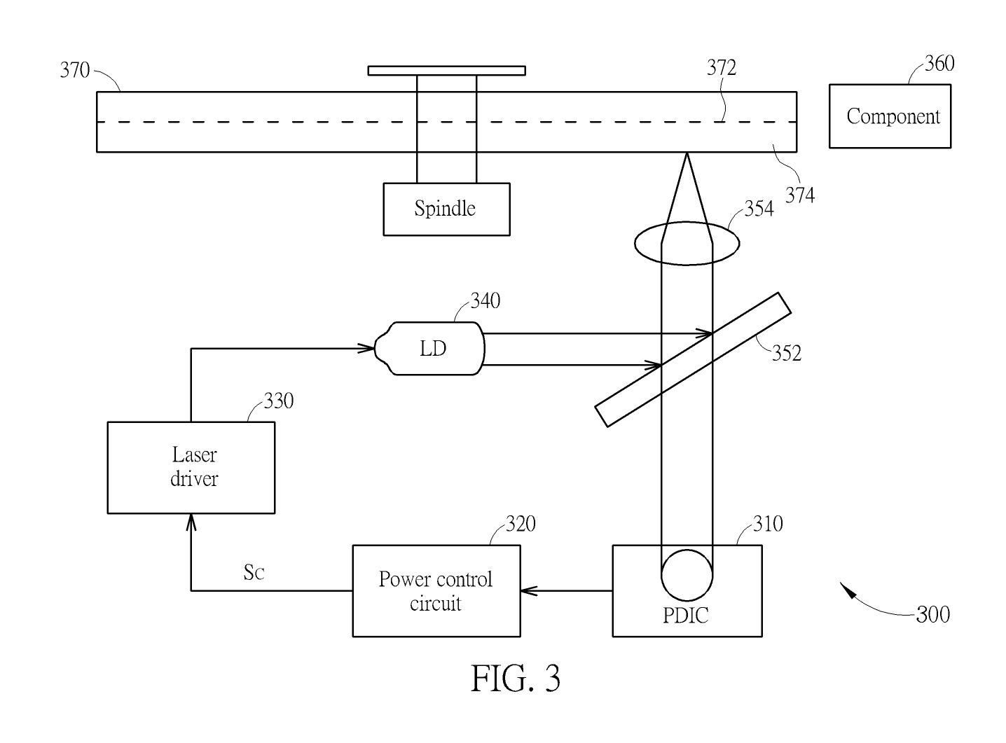

Please refer to FIG. 3, which is a diagram illustrating an optical disc drive 300 according to one embodiment of the present invention. As shown in FIG. 3, the optical disc drive 300 comprises a PDIC 310, a power control circuit 320, a laser driver 330, a light emitting unit (in this embodiment, a laser diode (LD) 340), two lens 352 and 354, and a component 360, where the component 360 can be any component having a suitable surface or smooth surface for reflecting light emitted from the LD 340. In addition, the optical disc drive 300 is arranged for writing data into an optical disc 370 or reading data from the optical disc 370, where the optical disc 370 mainly includes a reflective layer 372 for recording data and a plastic layer 374.

In the operations of the optical disc drive 300, the power control circuit 320 is arranged for generating to a control signal S_{c}, and the laser driver 330 receives the control signal to control a current of the LD 340 (i.e. control a power of the LD 340). Then, the LD 340 emits light to the optical disc via the lens 350 and 354 to read data from the optical disc 370 or to write data into the optical disc 370. However, because the relationship between the control signal generated by the power control circuit 320 and the power of the LD 340 may not be always the same, therefore, the PDIC 310 and the power control circuit 320 provide a mechanism to accurately compensate/adjust the power of the LD 340.

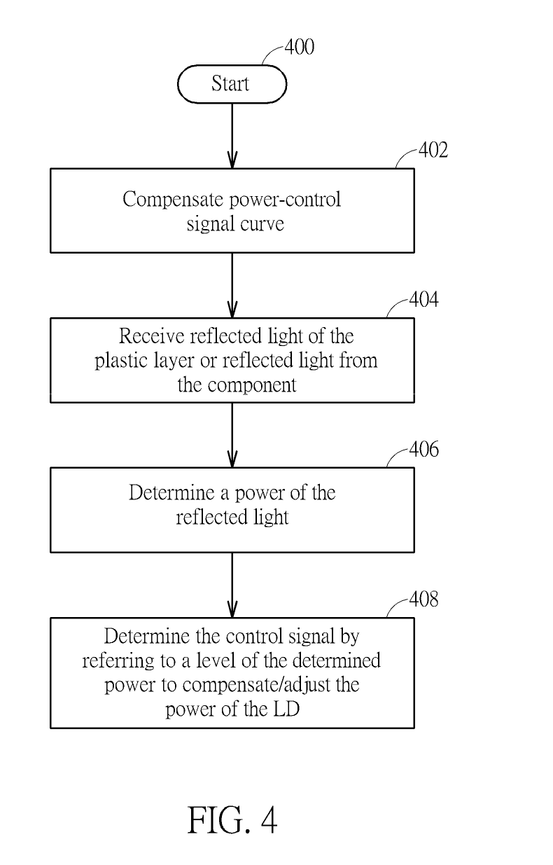

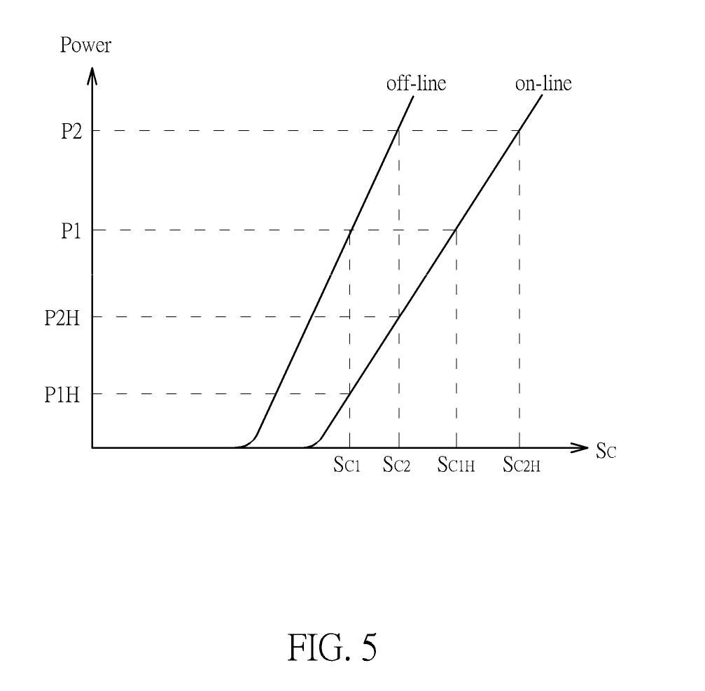

Please refer to FIG. 4, which is a flow chart of a method for controlling a power of the LD 340 according to a first embodiment of the present invention. It is noted that in the production line, the optical disc drive 300 has built an off-line power-control signal curve as shown in FIG. 5. In detail, referring to FIG. 4, in the production line, the power control circuit 320 generates at least two control signals S_{c1} and S_{c2} to control the power of the LD 340, and the PDIC 310 receives the reflected light (from the plastic layer 374 of the optical disc 370 or from the component 360) corresponding to the control signals S_{c1} and S_{c2}, respectively. Then, the power control circuit 320 can build an off-line power-control signal curve. It is noted that, in the embodiment it is assumed that the relationship (e.g. the ratio) between the power of the LD 340 and the power of the reflected light from the plastic layer 374/component 360 is determined and is always the same, therefore, the term “power” shown in FIG. 4 can refer to the power of the LD 340 or the power of the reflected light sensed by the PDIC 310. In other words, in the production line, the relationship between power of the LD 340/reflected power/control signal S_{c}are known. Referring to FIGS. 3-5 together, the flow is described as follows.

In Step 400, the flow starts. In Step 402, the power control circuit 320 compensates a power-control signal curve by determining at least two control signals and corresponding powers of the reflected light of the plastic layer 374 of the optical disc 370 or corresponding powers of the reflected light from the component 360 of the optical disc drive 300. In detail, because the off-line power-control signal curve may not be appropriate for use to compensate/adjust the power of the LD 340 due to the environment issue or laser diode aging issue, the power control circuit 320 generates at least two control signals S_{c1H} and S_{c2H} to control the power of the LD 340, and the PDIC 310 receives the reflected light (from the powdered material) corresponding to the control signals S_{c1H} and S_{c2H}, respectively. Then, the power control circuit 320 can build an on-line power-control signal curve.

Then, in Step 404, when the optical disc drive is in use, the PDIC 310 receives the reflected light of a plastic layer 374 of the optical disc 370 or the reflected light from the component 360 of the optical disc drive 300. In Step 406, the power control circuit 320 determines a power of the reflected light of the plastic layer 374 or a power of the reflected light from the component 360. Finally, in Step 408, the power control circuit 320 determines the control signal S_{c} by referring to a level of the determined power to compensate/adjust the power of the LD 340.

It is note that the steps 404-408 can be continuously performed or periodically performed to compensate/adjust the power of the LD 340.

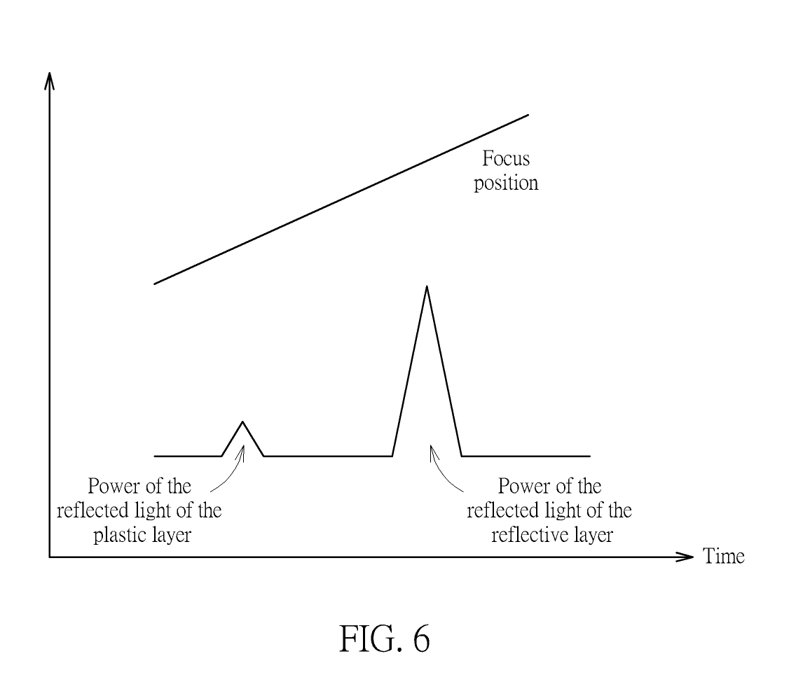

In addition, referring to FIG. 6, which is a diagram illustrating how to obtain the power of the reflected light of the plastic layer 374. Referring to FIG. 6, by moving the lens to adjust the focus position, the power of the reflected light of the plastic layer 374 and the power of the reflected light of the reflective layer 372 are obtained. Because the power of the reflected light of the plastic layer 374 should be much smaller than the power of the reflected light of the reflective layer 372, therefore, the power of the reflected light of the plastic layer 374 can be obtained by determining the powers of the reflected light sensed by the PDIC 310.

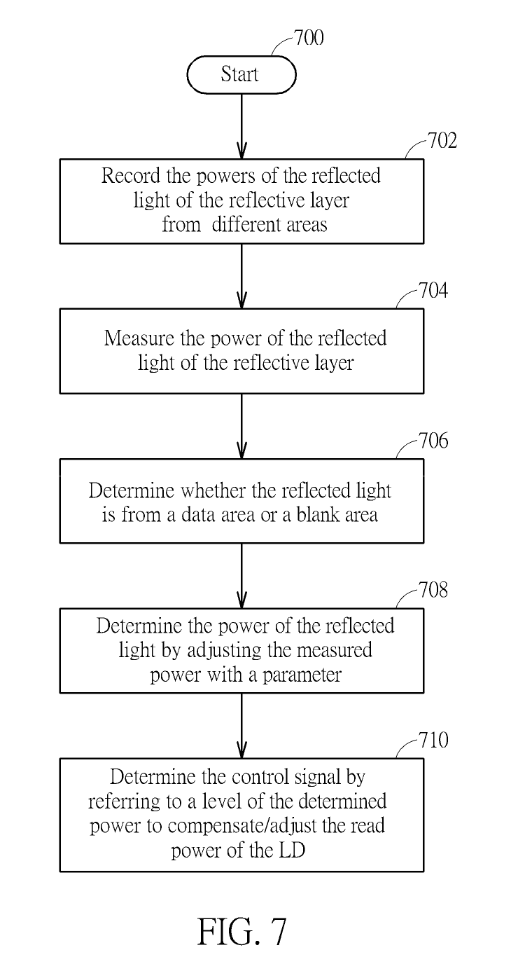

Please refer to FIG. 7, which is a flow chart of a method for controlling a power of the LD 340 according to a second embodiment of the present invention. Referring to FIG. 3 and FIG. 7 together, the flow is described as follows.

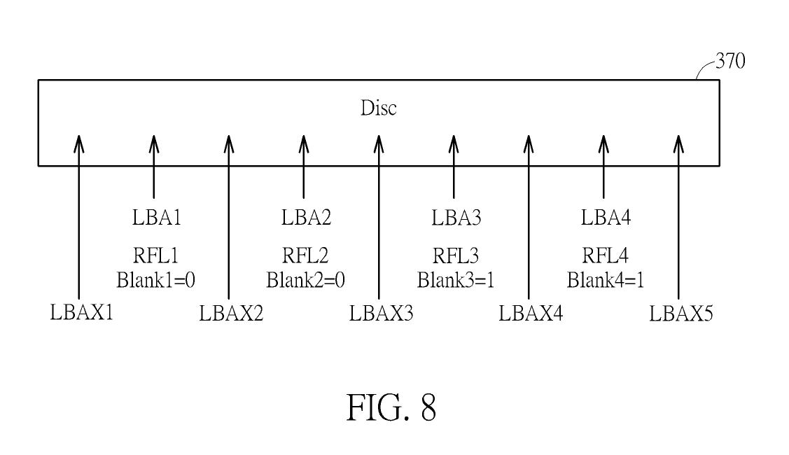

In Step 700, the flow starts. In Step 702, the PDIC 310 senses the reflected light of the reflective layer 372 from many different areas of the optical disc 300, and the power control circuit 320 records the powers of the reflected light of the reflective layer 372 from many different areas of the optical disc 300. For example, referring to FIG. 8, the optical disc 370 has four logical block addressing LBA1-LBA4, and the power control circuit 320 records the powers RFL1-RFL4 of the reflected light from the LBA1-LBA4. In addition, for the boundary between two LBAs such as LBAX1-LBAX5, an interpolation method can be performed to generate the power of the reflected light.

Then, in Step 704, when the power of the LD 340 is to be compensated/adjusted, the power control circuit 320 measures the power of the reflected light of the reflective layer 372 of the optical disc 370. In Step 706, the power control circuit 320 determines whether the reflected light is from a data area or a blank area of the reflective layer 372 of the optical disc 370, for example, in FIG. 8, “Blank1=0” means that the LBA1 is data area, and “Blank3=1” means that the LBA3 is blank area. Then, in Step 708, the power control circuit 320 determines the power of the reflected light of the reflective layer 372 by adjusting the measured power with a parameter corresponding to the data area or with another parameter corresponding to the blank area. Finally, in Step 710, the power control circuit 320 determines the control signal S_{c} by referring to a level of the determined power to compensate/adjust the read power of the LD 340.

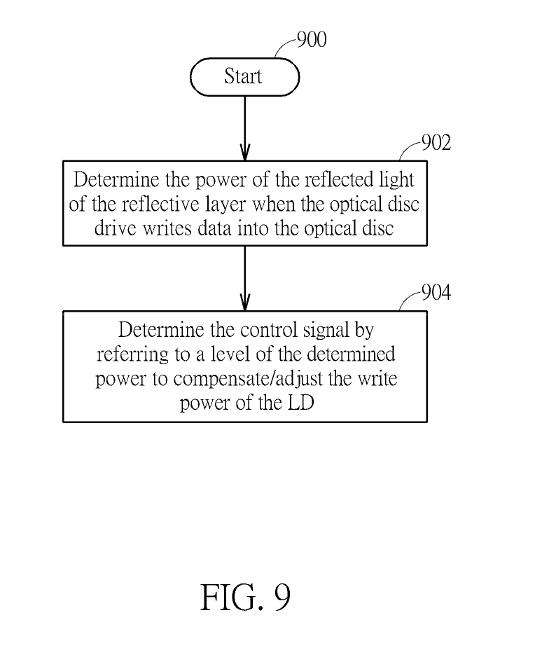

Please refer to FIG. 9, which is a flow chart of a method for controlling a power of the LD 340 according to a third embodiment of the present invention. In addition, in the flow chart of FIG. 9, it is assumed that the relationship between power of the LD 340/reflected power/control signal S_{c} are obtained. Referring to FIG. 3 and FIG. 9 together, the flow is described as follows.

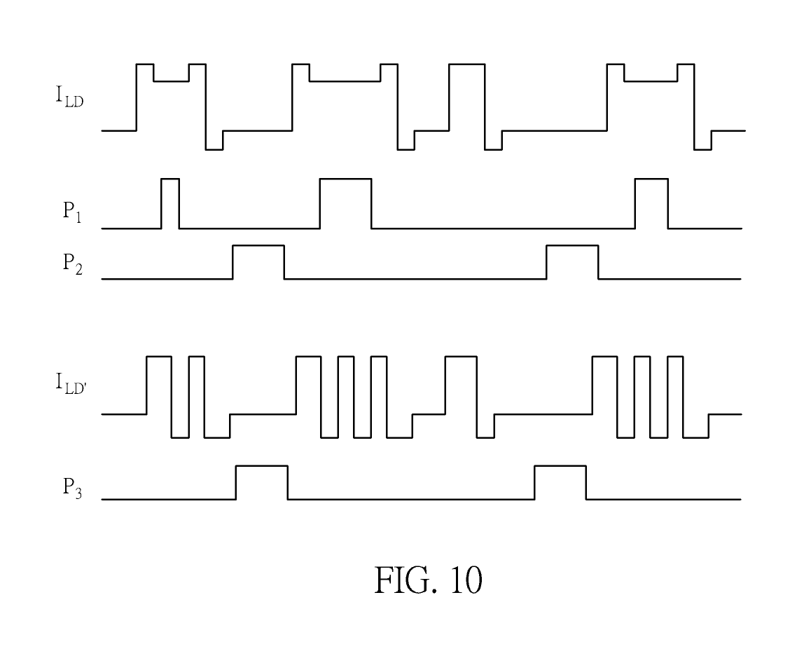

In Step 900, the flow starts. In Step 902, the power control circuit 320 determines the power of the reflected light of the reflective layer 372 of the optical disc 370 when the optical disc drive 300 writes data into the optical disc 370. For example, referring to FIG. 10, which shows the current of the LD 340 when the optical disc drive 300 writes data into the optical disc 370, that is I_{LD} or I_{LD}′, and the power control circuit 320 may use a sample and hold (S/H) circuit to use the sampling signals P1, P2 or P3 to sample the signal from the PDIC 310 (the waveform of the signal from the PDIC 310 is similar to I_{LD} or I_{LD}′) to obtain the power of the of the reflected light of the reflective layer 372 of the optical disc 370. Then, in Step 904, the power control circuit 320 determines the control signal S_{c} by referring to a level of the determined power to compensate/adjust the write power of the LD 340.

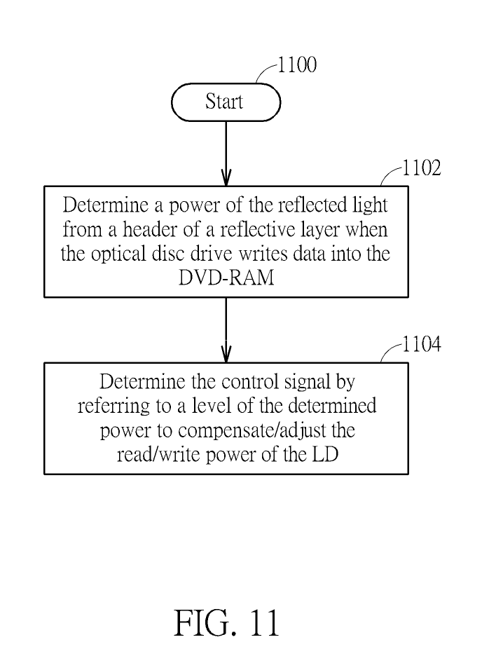

Please refer to FIG. 11, which is a flow chart of a method for controlling a power of the LD 340 according to a fourth embodiment of the present invention. In addition, in the flow chart of FIG. 11, it is assumed that the relationship between power of the LD 340/reflected power/control signal S_{c} are obtained, and the optical disc 370 is a Digital Versatile Disc Random Access Memory (DVD-RAM). Referring to FIG. 3 and FIG. 11 together, the flow is described as follows.

In Step 1100, the flow starts. In Step 1102, the power control circuit 320 determines a power of the reflected light from a header of a reflective layer 372 of the optical disc when the optical disc drive writes data into the DVD-RAM. Then, in Step 1104, the power control circuit 320 determines the control signal S_{c} by referring to a level of the determined power to compensate/adjust the read/write power of the LD 340.

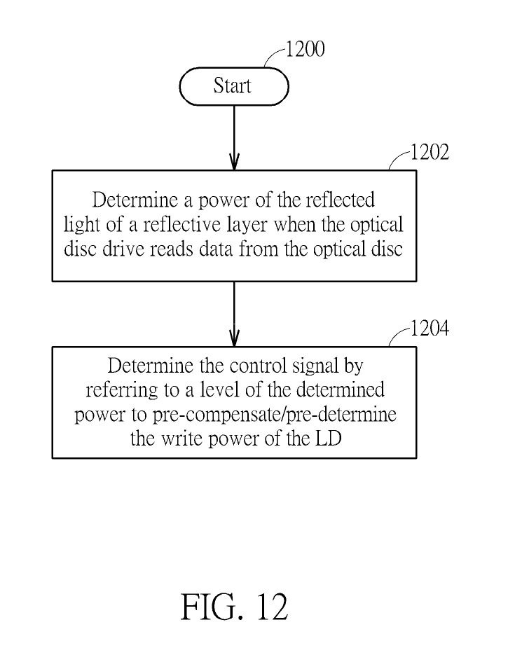

Please refer to FIG. 12, which is a flow chart of a method for controlling a power of the LD 340 according to a fifth embodiment of the present invention. In addition, in the flow chart of FIG. 12, it is assumed that the relationship between power of the LD 340/reflected power/control signal S_{c} are obtained. Referring to FIG. 3 and FIG. 12 together, the flow is described as follows.

In Step 1200, the flow starts. In Step 1202, the power control circuit 320 determines a power of the reflected light of a reflective layer 372 of the optical disc 370 when the optical disc drive 300 reads data from the optical disc 370. Then, in Step 1204, the power control circuit 320 determines the control signal S_{c} by referring to a level of the determined power to pre-compensate/pre-determine the write power of the LD 340 for further use.

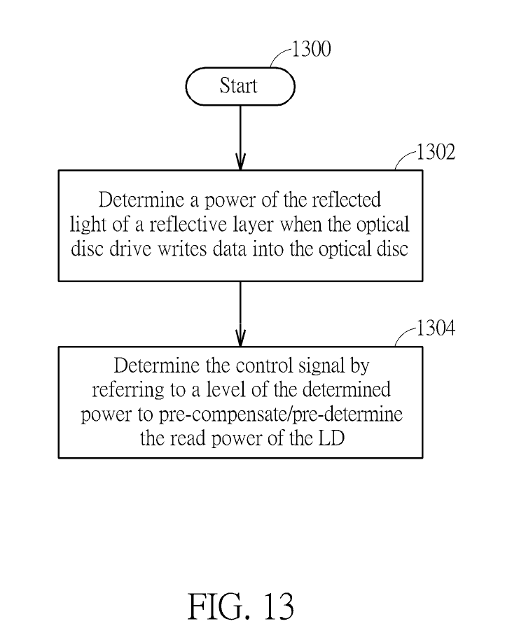

Please refer to FIG. 13, which is a flow chart of a method for controlling a power of the LD 340 according to a sixth embodiment of the present invention. In addition, in the flow chart of FIG. 13, it is assumed that the relationship between power of the LD 340/reflected power/control signal S_{c} are obtained. Referring to FIG. 3 and FIG. 13 together, the flow is described as follows.

In Step 1300, the flow starts. In Step 1302, the power control circuit 320 determines a power of the reflected light of a reflective layer 372 of the optical disc 370 when the optical disc drive 300 writes data into the optical disc 370. Then, in Step 1304, the power control circuit 320 determines the control signal S_{c} by referring to a level of the determined power to pre-compensate/pre-determine the read power of the LD 340 for further use.

For the above-mentioned embodiments about the step of determining the control signal S_{c} by referring to a level of the determined power to compensate the power of the LD 340, for example, assuming that the LD 340 is required to emit light having power PW1, and because the power of the reflected light from the powdered material is determined and is always the same, the target power of the reflected light is known (hereafter PW2). Therefore, the power control circuit 320 may refer to the power of the reflected light to compensate/adjust the power of the LD 340 to make the power of the reflected light equal to or closer to PW2, and at this time the LD 340 should have the required power PW1.

In light of above, in the method and associated apparatus of the present invention, a power of the reflected light is used to determine the control signal to control the power of the laser diode, therefore, the FMD and the temperature sensor are not used to save the manufacturing cost. In addition, the method and apparatus of the present invention does not need to build models and the power of the laser diode can be accurately compensated even under environment issue or laser diode aging issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a power of a laser emitting unit, comprising:
receiving a reflected light from an object, where the object reflects light emitted from the laser emitting unit;
determining a power of the reflected light; and
determining a control signal by referring to a level of the power of the reflected light to control the power of the laser emitting unit.

2. The method of claim 1, wherein the object is powdered material.

3. The method of claim 1, wherein the method is applied to a selective laser sintering (SLS) machine, and the object is a component within the SLS machine.

4. The method of claim 1, wherein the method is applied to an optical disc drive, and the object is an optical disc or a component of the optical disc drive, and the step of determining the power of the reflected light and the step of determining the control signal by referring to the level of the power of the reflected light to control the power of the laser emitting unit comprise:
determining a power of the reflected light of a plastic layer of the optical disc or determining a power of the reflected light from the component of the optical disc drive; and
determining the control signal by referring to the level of the determined power to control the power of the laser emitting unit.

5. The method of claim 4, further comprising:
compensating a power-control signal curve by determining at least two control signals and corresponding powers of the reflected light of the plastic layer of the optical disc or corresponding powers of the reflected light from the component of the optical disc drive; and
the step of determining the control signal by referring to the level of the determined power to control the power of the laser emitting unit comprises:
referring to the compensated power-control signal curve to determine the control signal by referring to the level of the determined power to control the power of the laser emitting unit.

6. The method of claim 1, wherein the method is applied to an optical disc drive, the object is an optical disc, and the step of determining the power of the reflected light and the step of determining the control signal by referring to the level of the power of the reflected light to control the power of the laser emitting unit comprise:
determining a power of the reflected light of a reflective layer of the optical disc; and
determining the control signal by referring to the level of the determined power to control the power of the laser emitting unit.

7. The method of claim 6, wherein the step of determining the power of the reflected light of the reflective layer of the optical disc comprises:
measuring the power of the reflected light of the reflective layer of the optical disc;
determining whether the reflected light is from a data area or a blank area of the reflective layer of the optical disc; and
determining the power of the reflected light of the reflective layer of the optical disc by adjusting the measured power with a parameter corresponding to the data area or with another parameter corresponding to the blank area.

8. The method of claim 1, wherein the method is applied to an optical disc drive, the object is an optical disc, and the step of determining the power of the reflected light comprises:
determining the power of the reflected light of a reflective layer of the optical disc when the optical disc drive writes data into the optical disc.

9. The method of claim 1, wherein the method is applied to an optical disc drive, the object is a Digital Versatile Disc Random Access Memory (DVD-RAM), and the step of determining the power of the reflected light comprises:
determining a power of the reflected light from a header of a reflective layer of the optical disc when the optical disc drive writes data into the DVD-RAM.

10. The method of claim 1, wherein the method is applied to an optical disc drive, and the object is an optical disc or a component of the optical disc drive, and the step of determining the power of the reflected light and the step of determining the control signal by referring to the level of the power of the reflected light to control the power of the laser emitting unit comprise:
determining a power of the reflected light of a reflective layer of the optical disc when the optical disc drive reads data from the optical disc; and
determining the control signal by referring to the level of the determined power to control the write power of the laser emitting unit.

11. The method of claim 1, wherein the method is applied to an optical disc drive, and the object is an optical disc or a component of the optical disc drive, and the step of determining the power of the reflected light and the step of determining the control signal by referring to the level of the power of the reflected light to control the power of the laser emitting unit comprise:
determining a power of the reflected light of a reflective layer of the optical disc when the optical disc drive writes data into the optical disc; and
determining the control signal e by referring to the level of the determined power to control the read power of the laser emitting unit.

12. An apparatus for controlling a power of a laser emitting unit, comprising:
a photo detector integrated circuit, for receiving a reflected light from an object, where the object reflects light emitted from the laser emitting unit; and
a power control circuit, coupled to the photo detector integrated circuit, for determining a power of the reflected light, and determining a control signal by referring to a level of the power of the reflected light to control the power of the laser emitting unit.

13. The apparatus of claim 12, wherein the object is powdered material.

14. The apparatus of claim 12, wherein the apparatus is applied to a selective laser sintering (SLS) machine, and the object is a component within the SLS machine.

15. The apparatus of claim 12, wherein the apparatus is applied to an optical disc drive, and the object is an optical disc or a component of the optical disc drive, and the power control circuit determines a power of the reflected light of a plastic layer of the optical disc or determines a power of the reflected light from the component of the optical disc drive, and the power control circuit determines the control signal by referring to the level of the determined power to control the power of the laser emitting unit.

16. The apparatus of claim 15, wherein the power control circuit further compensates a power-control signal curve by determining at least two control signals and corresponding powers of the reflected light of the plastic layer of the optical disc or corresponding powers of the reflected light from the component of the optical disc drive; and the power control circuit refers to the compensated power-control signal curve to determine the control signal by referring to the level of the determined power to control the power of the laser emitting unit.

17. The apparatus of claim 12, wherein the apparatus is applied to an optical disc drive, the object is an optical disc, and the power control circuit determines a power of the reflected light of a reflective layer of the optical disc, and determines the control signal by referring to the level of the determined power to control the power of the laser emitting unit.

18. The apparatus of claim 17, wherein the power control circuit measures the power of the reflected light of the reflective layer of the optical disc, determines whether the reflected light is from a data area or a blank area of the reflective layer of the optical disc, and determines the power of the reflected light of the reflective layer of the optical disc by adjusting the measured power with a parameter corresponding to the data area or with another parameter corresponding to the blank area.

19. The apparatus of claim 12, wherein the apparatus is applied to an optical disc drive, the object is an optical disc, and the power control circuit determines the power of the reflected light of a reflective layer of the optical disc when the optical disc drive writes data into the optical disc.

20. The apparatus of claim 12, wherein the apparatus is applied to an optical disc drive, the object is a Digital Versatile Disc Random Access Memory (DVD-RAM), and the power control circuit determines a power of the reflected light from a header of a reflective layer of the optical disc when the optical disc drive writes data into the DVD-RAM.
